(19) United States
(12) Patent Application Publication
(10) Pub. No.: US 2009/0283366 A1
(43) Pub. Date: Nov. 19, 2009

(54) LIFTING ASSEMBLY

(75) Inventor: Joseph B. Lee, Santa Clara, CA (US)

Correspondence Address: MAIER & MAIER, PLLC, 1000 DUKE STREET, ALEXANDRIA, VA, 22314, US

(73) Assignee: K&L Supply Company, Santa Clara, CA (US)

(21) Appl. No.: 12/465,009

(22) Filed: May 13, 2009

Related U.S. Application Data
(60) Provisional application No. 61/071,746, filed on May 13, 2008.

(51) Int. Cl. B66F 7/06

(52) U.S. Cl. 187/207

(57) ABSTRACT

A lifting assembly may include a base frame; a support assembly coupled to the base frame wherein the support assembly may include a rotating member pivotally coupled to the base frame; a support arm coupled to the rotating member; and a lifting arm coupled to the support arm; and a lifting mechanism that may include a roller shaft; a link arm pivotally coupled to the roller shaft and the support arm; a roller coupled to the roller shaft and the link arm; and a screw coupled to the base frame and threadably coupled to the roller shaft.

### RELATED APPLICATIONS

This application claims priority, under 35 U.S.C. §119(e), to U.S. Provisional Patent Application Ser. No. 61/071,746, filed May 13, 2008, the disclosure of which is incorporated by reference herein in its entirety.

### BACKGROUND

Lifts are commonly used to enable a user to lift heavy transportational equipment partially off the ground such that the user may work on the transportational equipment. Examples of transportational equipment may include automobiles, motorcycles, all-terrain vehicles (ATV) and/or other personal transportational equipment.

In some embodiments, a plurality of lifts may be used to lift the equipment to a working level and to also lift at least a portion of the equipment that the user desires to work on. For example, a user may lift an ATV to a working height using a large lift, and then the user may lift a rear end of the ATV off a lift surface using a smaller lift. As a result, the user may work on the ATV at a comfortable height.

### SUMMARY

According to at least one embodiment, a lifting assembly may include a base frame; a support assembly coupled to the base frame wherein the support assembly may include a rotating member pivotally coupled to the base frame; and a support arm coupled to the rotating member; and a lifting mechanism that may include a roller shaft; a link arm pivotally coupled to the roller shaft and the support arm; a roller coupled to the roller shaft and the link arm; and a screw coupled to the base frame and threadably coupled to the roller shaft.

In an exemplary method of lifting a desired object, the method may include coupling a lifting assembly to a lift platform, wherein the lifting assembly may include a base frame and a pair of support arms pivotally coupled to the base frame; rotating in a first direction an adjuster member that may include a second gear coupled thereto; rotating a screw that may include a first gear coupled thereto, wherein the first gear is interlockingly coupled to the second gear; and pivoting the pair of support arms about a pivot shaft coupled to the base frame such that the pair of support arms rotate substantially away from the base frame.

### BRIEF DESCRIPTION OF THE FIGURES

Advantages of embodiments of the utility lift will be apparent from the following detailed description of the exemplary embodiments thereof, which description should be considered in conjunction with the accompanying drawings in which:

FIG. 1 is a side perspective view of a lifting assembly;

FIG. 2 is a side perspective view of the lifting assembly shown in FIG. 1;

FIG. 3a is a partially exploded perspective view of the lifting assembly shown in FIG. 1;

FIG. 3b is an exploded view of a portion of the lifting assembly shown in FIG. 3a;

FIG. 3c is a perspective view of an upper plate that may be used with the lifting assembly shown in FIG. 3a; and

FIG. 4 is a partially exploded perspective view of the lifting assembly shown in FIG. 1.

### DETAILED DESCRIPTION

Aspects of the lifting assembly are disclosed in the following description and related drawings directed to specific embodiments of the lifting assembly. Alternate embodiments may be devised without departing from the spirit or the scope of the lifting assembly. Additionally, well-known elements of exemplary embodiments of the lifting assembly will not be described in detail or will be omitted so as not to obscure the relevant details of the lifting assembly. Further, to facilitate an understanding of the description a discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the lifting assembly”, “embodiment” or “lifting assembly” do not require that all embodiments of the lifting assembly include the discussed feature, advantage or mode of operation.

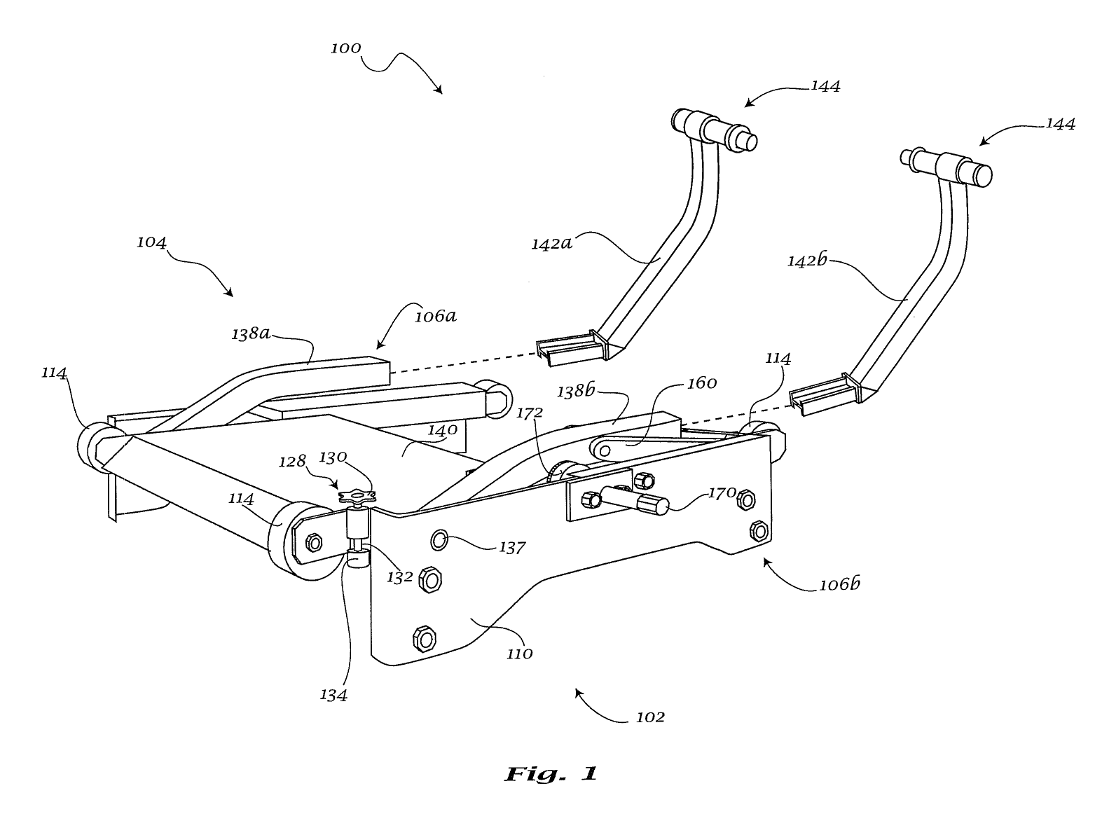

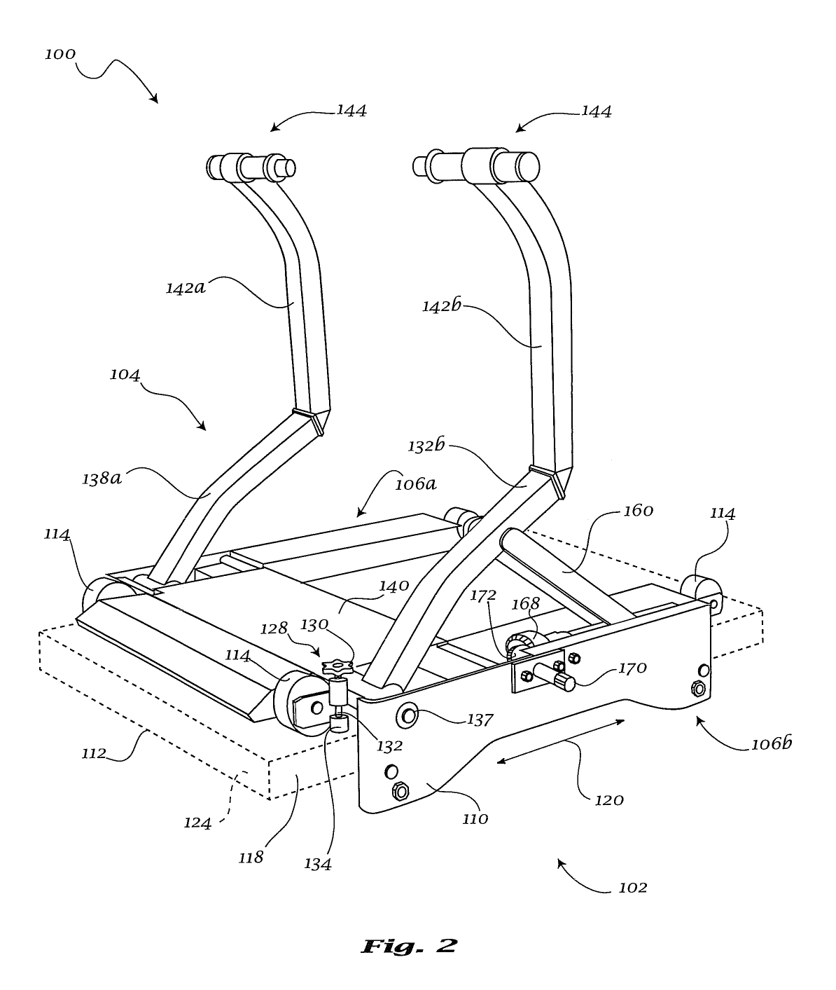

Referring to FIGS. 1-4, in the exemplary embodiment, lifting assembly 100 may include a base frame 102 and a support assembly 104 coupled thereto. In the exemplary embodiment, base frame 102 may include a pair of side members 106a and 106b that may be coupled together using a stabilizing member 108. In one embodiment, side members 106a and 106b may have a side panel 110 coupled thereto that facilitates coupling lifting assembly 100 to a lift platform 112 (shown in FIG. 2) of a lift apparatus (not shown), as described in more detail below. Side members 106a and 106b may also have a wheel 114 coupled thereto. Moreover, an additional pair of wheels 114 may be coupled to a front end of base frame 102. In one embodiment, wheels 114 may facilitate moving lifting assembly 100 on a surface, such as lift platform 112 of a lift apparatus.

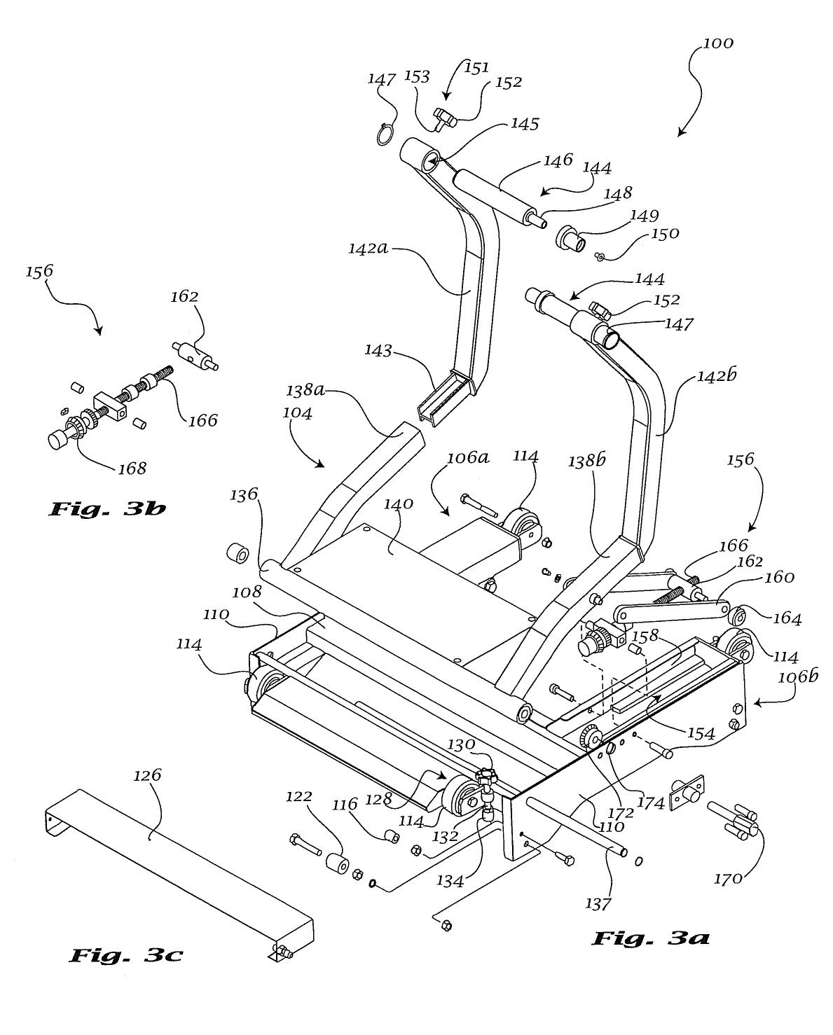

In the exemplary embodiment, a plurality of spacers 116 may be coupled to side panels 110. In one embodiment, spacers 116 may contact a pair of vertical outer sidewalls 118 (shown in FIG. 3) of lift platform 112. As a result, spacers 116 may facilitate preventing lifting assembly 100 from moving in a width-wise direction. Moreover, spacers 116 may also facilitate safe moving of lifting assembly 100 in a substantially horizontal direction, or length-wise direction, as indicated by arrow 120 (shown in FIG. 2). Base frame 102 may also include a plurality of rollers 122 that may be coupled to side panels 110. In one embodiment, rollers 122 may contact an underside 124 of lift platform 112. As a result, rollers 122 may facilitate coupling lifting assembly 100 to lift platform 112 and facilitate preventing accidental dismounting of lifting assembly 100 from lift platform 112. Moreover, an upper plate 126 (shown in FIG. 3) may be coupled to lift platform 112 to function as a stop-guard, which facilitates preventing lifting assembly 100 from sliding off an end of lift platform 112.

Base frame 102 may also include a locking assembly 128 that facilitates preventing forward and backward horizontal movement of base frame 102 with respect to lift platform 112. In one embodiment, locking assembly 128 may include an adjustment knob 130, a threaded shaft 132 coupled thereto and a spacer 134 coupled to an end of shaft 132, wherein spacer 134 is positioned substantially adjacent lift platform 112. In one embodiment, shaft 132 may be threadably coupled to base frame 102 such that locking assembly 128 facilitates preventing forward and backward horizontal movement.

For example, during operation a user may rotate adjustment knob 130 such that shaft 132 extends substantially towards lift platform 112 causing spacer 134 to apply a force to lift platform 112. In one embodiment, the force may be sufficient to facilitate preventing base frame 102 from moving in a substantially horizontal direction with respect to lift platform 112. In the event the user wants to move base frame 102, the user may rotate adjustment knob 130 in a substantially opposite direction such that the force between spacer 134 and lift platform 112 is substantially reduced.

In the exemplary embodiment, support assembly 104 may include a rotating member 136 (shown in FIG. 3) and a pair of support arms 138a and 138b coupled thereto. Rotating member 136 may be pivotally coupled to base frame 102 using a pivot shaft 137 such that support arms 138a and 138b may pivot about pivot shaft 137 and rotate with respect to base frame 102, as described in more detail below. Base frame 102 may also include a cover 140 that facilitates covering a portion of base frame 102, and more specifically, rotating member 136. In one embodiment, support arms 138a and 138b may be substantially parallel to one another. Alternatively, support arms 138a and 138b may not be substantially parallel. Support arms 138a and 138b may also have a bend such that support arms 138a and 138b may have a substantially arcuate shape. Alternatively, support arms 138a and 138b may have any type of shape that enables lifting assembly 100 to function as described herein.

Support assembly 104 may also include a pair of lifting arms 142a and 142b that may be coupled to support arms 138a and 138b, respectively. Lifting arms 142a and 142b may include an attachment portion 143 that extends away therefrom. In one embodiment, lifting arms 142a and 142b may be slidably coupled to support arms 138a and 138b, respectively using attachment portion 143. Lifting arms 142a and 142b may also have a bend therein such that lifting arms 142a and 142b may have a substantially arcuate shape. Alternatively, lifting arms 142a and 142b may have any type of shape that enables lifting assembly 100 to function as described herein.

In one embodiment, lifting arms 142a and 142b may include an adjustable shaft 144 slidably coupled to an end of lifting arms 142a and 142b. Adjustable shaft 144 may include a substantially cylindrical-shaped body 146 that has an end stop 147 coupled at one end of adjustable shaft 144 and an end tip 148 coupled to another end of adjustable shaft 144. In one alternative embodiment, end stop 147 may be, but not limited to, a circular clip. In another alternative embodiment, body 146 may include any shape that enables lifting assembly to function as described herein. In one embodiment, end tip 148 may include a plastic cover 149 coupled thereto using a fastener 150. In an alternative embodiment, fastener 150 may be an Allen bolt. Lifting arms 142a and 142b may also include an adjustment bore 145 defined in an end of lifting arms 142a and 142b, wherein the end is positioned substantially opposite of the end coupled to attachment portion 143. A locking mechanism 151 may be coupled to the end of lifting arms 142a and 142b to facilitate locking adjustable shaft 144 thereto in a specific position with respect to lifting arms 142a and 142b. In one embodiment, locking mechanism 151 may include an adjustment knob 152 and a pin portion 153, wherein pin portion 152 may be coupled to knob 152 and lifting arms 142a and 142b. In one embodiment, pin portion 153 may be threadably coupled to lifting arms 142a and 142b such that pin portion 153 extends partially into adjustment bore 145.

In the exemplary embodiment, adjustment shaft 144 may be inserted within adjustment bore 145 such that end tip 148 faces the opposite lifting arm. End stop 147 may be coupled to adjustment shaft 144 to facilitate preventing adjustment shaft from sliding out of adjustment bore 145.

Turning back to base frame 102, in one embodiment, side member 106b may include a cavity 154 defined therein that may partially house a lifting mechanism 156. A pair of channels 158 may be defined within base frame 102 and positioned substantially within cavity 154, wherein the pair of channels 158 may facilitate channeling lifting mechanism 156 within cavity 154, as described in more detail below.

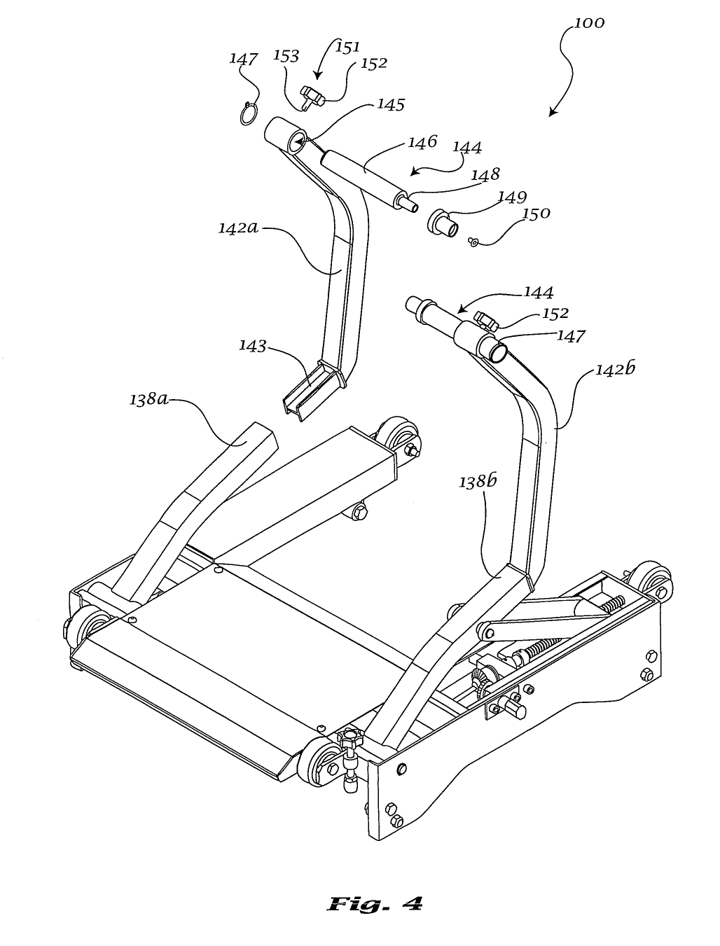

In the exemplary embodiment, lifting mechanism 156 may be coupled to base frame 102 and at least one of support arms 138a and 138b, as shown in FIGS. 3 and 4. In one embodiment, lifting mechanism 156 facilitates pivoting support arms 138a and 138b, and lifting arms 142a and 142b about pivot shaft 137. In one embodiment, lifting mechanism 156 may be a jackscrew and may include a pair of link arms 160, wherein a first end of link arms 160 may be rotatably coupled to support arms 138a and 138b and a second end of link arms 160 may be rotatably coupled to a roller shaft 162. Moreover, a pair of rollers 164 may be coupled to roller shaft 162, wherein rollers 164 may roll and/or slide within channel 158, which may facilitate slidably coupling link arms 160 to base frame 102. Lifting mechanism 156 may also include a screw 166 that may include a first gear 168 coupled to a proximate end of screw 166 such that rotation of first gear 168 facilitates rotating screw 166. A distal end of screw 166 may be threadably coupled to roller shaft 162. As a result, roller shaft 162 may move along the length of screw 166 as screw 166 rotates, as described in more detail below.

Lifting mechanism 156 may also include as adjuster member 170 that may include a second gear 172 coupled thereto. In the exemplary embodiment, adjuster member 170 may extend through an aperture 174 defined in side panel 110. Second gear 172 may be positioned within cavity 154 such that second gear 172 may be oriented substantially perpendicular to first gear 168. For example, first gear 168 and second gear 172 may each include a plurality of teeth (not shown) extending substantially radially therefrom. The teeth may be oriented such that the teeth of first gear 168 may be interleaved or interlocked between the teeth of second gear 172. As a result, second gear 172 may be interlockingly coupled to first gear 168 such that rotation of second gear 172 facilitates rotating first gear 168 and more specifically, screw 166. In one embodiment, a crank (not shown) may be coupled to an end of adjuster member 170 to facilitate rotating adjuster member 170. As a result, lifting mechanism 156 facilitates transforming lifting assembly 100 between a collapsed position (shown in FIG. 1) and an expanded position (shown in FIG. 2).

During operation, lifting assembly 100 may be placed on lift platform 112 of the lifting apparatus. In one embodiment, the user may couple lifting assembly 100 to lift platform 112 by sliding rollers 122 under lift platform 112 such that rollers 122 contact underside 124, which facilitates preventing lifting assembly 100 from dismounting from lift platform 112. Moreover, lifting assembly 100 may be aligned on lift platform 112 such that spacers 116 may contact vertical sidewalls 118, which facilitates preventing width-wise movement of lifting assembly 100 with respect to lift platform 112.

Once lifting assembly 100 is coupled to lift platform 112, the user may position lifting assembly 100 in a substantially collapsed position, as shown in FIG. 1. The user may slide lifting assembly 100 along lift platform 112 to a desired position. In a non-limiting example, the user may position lifting assembly 100 substantially under a motorcycle (not shown) that is coupled to lift platform 112. For example, the user may position lifting assembly 100 under the motorcycle such that attachment assemblies 142 of support arms 138a and 138b are positioned substantially under the footpegs of the motorcycle. It should be understood that lifting assembly 100 may be used to lift any type of transportational equipment the user wishes to lift.

Once lifting assembly 100 is in a desired position, the user may rotate adjustment knob 130 of locking assembly 128 to facilitate locking lifting assembly 100 in position with respect to lift platform 112. In one embodiment, the user may rotate adjustment knob 130 such that threaded shaft 132 and spacer 134 move substantially towards lift platform 112, wherein the force of spacer 134 on lift platform 112 facilitates locking lifting assembly 100 in place on lift platform 112. The user may then rotate adjuster member 170 of lifting mechanism 156 to facilitate raising supports arms 138a and 138b. In the exemplary embodiment, rotation of adjuster member 170 also rotates second gear 172, which facilitates rotating first gear 168. Rotation of first gear 168 results in the rotation of screw 166. As a result, rotation of adjuster member 170 facilitates rotating screw 166

Moreover, in the exemplary embodiment, the rotation of screw 166 facilitates moving roller shaft 162 along a length of screw 166. For example, in one embodiment, roller shaft 162 may be positioned on the distal end of screw 166. Rotation of screw 166 in a first direction may cause roller shaft 162 to move towards the proximate end of screw 166 and towards first gear 168. As roller shaft 162 moves towards first gear 168, rollers 164 may roll or slide within channel 158. Moreover, roller shaft 162 causes link arms 160 to apply a force to support arm 138b, which facilitates rotating the rotating member 136, and more specifically support assembly 104 about pivot shaft 137.

Next, once support arms 138a and 138b have rotated partially away from base frame 102, the user may couple lifting arms 142a and 142b to support arms 138a and 138b, respectively. In one embodiment, attachment portion 143 of lifting arms 142a and 142b may be slidably inserted within a cavity (not shown) defined within support arms 138a and 138b. As such, lifting arms 142a and 142b may be removably coupled to support arms 138a and 138b. Once lifting arms 142a and 142b have been coupled to support arms 138a and 138b, respectively, the user may continue to rotate support arms 138a and 138b away from base frame 102. As a result, support arms 138a and 138b and lifting arms 142a and 142b may rotate away from base frame 102 such that lifting assembly substantially transforms from a collapsed position to an expanded position.

In one embodiment, end tip 148 of lifting arms 142a and 142b may be inserted into an aperture (not shown) defined on a frame (not shown) of the motorcycle (not shown). Adjustment shaft 144 may be adjusted with respect to lifting arms 142a and 142b such that end tip 148 may be inserted into the motorcycle frame aperture. Once end tips 148 are positioned within the motorcycle frame aperture, adjustment shafts 144 may be locked into place using locking mechanism 152. In an alternative embodiment, adjustment shafts 144 and end tips 148 may be coupled to any part of the motorcycle frame known to a person having ordinary skill in the art that enables lifting assembly 100 to function as described herein.

Once the motorcycle is securely coupled to lifting apparatus 100, the user may continue to rotate adjuster member 170 such that support arms 138a and 138b and lifting arms 142a and 142b continue to rotate away from base frame 102, which facilitates lifting at least a portion of the motorcycle off lift platform 112. As a result, in the non-limiting motorcycle example, the user may easily access the rear tire which enables the user to replace the wheel, conduct rear brake and disk maintenance, conduct suspension tuning and/or repair, and/or any other service procedure that requires the motorcycle to be partially lifted off a surface.

In the event, the user desires to collapse lifting assembly 100, the user may rotate adjuster member 170 in a second direction that is substantially opposite of the first direction, such that screw 166 rotates in a direction that facilitates moving roller shaft 162 towards the distal end of screw 166. As a result, link arms 160 enable support assembly 104 to rotate about pivot shaft 137 towards base frame 102, such that lifting assembly 100 transforms from the expanded position to the collapsed position.

The foregoing description and accompanying figures illustrate the principles, preferred embodiments and modes of operation of the lifting assembly. However, the lifting assembly should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A lifting assembly comprising:
a base frame;
a support assembly coupled to said base frame wherein said support assembly comprises:
a rotating member pivotally coupled to said base frame;
a support arm coupled to said rotating member; and
a lifting arm coupled to said support arm; and
a lifting mechanism comprising:
a roller shaft;
a link arm pivotally coupled to said roller shaft and said support arm;
a roller coupled to said roller shaft and said link arm; and
a screw coupled to said base frame and threadably coupled to said roller shaft.

2. A lifting assembly in accordance with claim 1 further comprising:
a cavity defined within said base frame; and
a channel defined in said base frame wherein said channel is positioned substantially within said cavity, said channel facilitates engaging said roller of said lifting mechanism.

3. A lifting assembly in accordance with claim 1 further comprising a bore defined in an end of said lifting arm.

4. A lifting assembly in accordance with claim 3 further comprising an adjustment shaft coupled to an end of said lifting arm and positioned within said bore, said adjustment shaft comprising:
a cylindrical body;
an end stop coupled to one end of said cylindrical body; and
an end tip extending away from another end of said cylindrical body.

5. A lifting assembly in accordance with claim 4, further comprising a locking mechanism coupled to said lifting arm, said locking mechanism facilitates locking adjustment shaft with respect to said lifting arm.

6. A lifting assembly in accordance with claim 4, wherein said end cap comprises a plastic cover coupled thereto.

7. A lifting assembly in accordance with claim 4, wherein said end stop may be a circular clip.

8. A lifting assembly in accordance with claim 1 further comprising:
a plurality of spacers coupled to said base frame and extending away therefrom, said plurality of spacers facilitate stabilizing said lifting assembly with respect to a lift platform.

9. A lifting assembly in accordance with claim 1 further comprising:
a plurality of rollers coupled to said base frame and extending away therefrom, said plurality of spacers facilitate stabilizing said lifting assembly with respect to a lift platform.

10. A lifting assembly in accordance with claim 1 further comprising a locking assembly coupled to said base frame, said locking assembly comprises:
an adjustment knob;
a locking assembly spacer; and
a shaft threadably coupled to said base frame, wherein said adjustment knob and said spacer are coupled to said shaft.

11. A lifting assembly in accordance with claim 1 further comprising an upper plate coupled to a lift platform, wherein said upper plate facilitates preventing said lifting assembly from decoupling from said lift platform.

12. A lifting assembly in accordance with claim 1, wherein said support arm further comprises a bend such that said support arm has a substantially arcuate shape.

13. A lifting assembly in accordance with claim 1, wherein said lifting arm further comprises a bend such that said lifting arm has a substantially arcuate shape.

14. A lifting assembly in accordance with claim 1, wherein said lifting arm further comprises an attachment portion extending away therefrom.

15. A lifting assembly in accordance with claim 1, wherein said lifting mechanism further comprises a first gear coupled to said screw.

16. A lifting assembly in accordance with claim 15 further comprising:
an aperture defined in said base frame;
an adjuster member coupled to said base frame and positioned at least partially within said aperture; and
a second gear coupled to said adjuster member, wherein said second gear is interlockingly coupled to said first gear such that rotation of said second gear facilitates rotating said first gear.

17. A method of lifting an object, said method comprises:
coupling a lifting assembly to a lift platform, wherein the lifting assembly includes a base frame and a pair of support arms pivotally coupled to the base frame;
coupling a pair of lifting arms to the pair of support arms;
rotating in a first direction an adjuster member that includes a first gear coupled thereto;
rotating a screw that includes a second gear coupled thereto, wherein the second gear is interlockingly coupled to the first gear; and
pivoting the pair of support arms about a pivot shaft coupled to the base frame such that at least one of the pair of support arms and the pair of lifting arms rotate substantially away from the base frame.

18. A method in accordance with claim 17 further comprising:
coupling an object to the pair of lifting arms using an adjustment shaft, said step of coupling an object to the pair of lifting arms comprises:
inserting at least a portion of the adjustment shaft into the object, wherein the adjustment shaft is coupled to the pair of lifting arms; and
securing the adjustment shaft with respect to the pair of lifting arms using an adjustment shaft locking mechanism.

19. A method in accordance with claim 17 further comprising:
locking the lifting assembly with respect to the lift platform, wherein said step of locking the lifting assembly with respect to the lift platform comprises:
rotating a locking mechanism that is coupled to the base frame; and
engaging at least a portion of the locking mechanism with the lift platform such that a sufficient amount of force is generated to facilitate preventing substantially horizontal movement of the lifting assembly with respect to the lift platform.

20. A method in accordance with claim 17 further comprising:
lowering an object, wherein said step of lowering the object comprises:
rotating in a second direction the adjuster member and first gear, wherein the second direction is substantially opposite of the first direction;
rotating the screw and the second gear; and
pivoting the pair of support arms about the pivot shaft such that at least one of the pair of support arms and the pair of lifting arms rotate substantially towards the base frame.
